(19) United States
(12) Patent Application Publication
(10) Pub. No.: US 2013/0064757 A1
(43) Pub. Date: Mar. 14, 2013

(54) METHODS FOR FORMING ZEOLITES FROM HOMOGENEOUS AMORPHOUS SILICA ALUMINA

(71) Applicants: Deng-Yang Jan, Elk Grove Village, IL (US); Jaime G. Moscoso, Mt. Prospect, IL (US)

(72) Inventors: Deng-Yang Jan, Elk Grove Village, IL (US); Jaime G. Moscoso, Mt. Prospect, IL (US)

(73) Assignee: UOP LLC, Des Plaines, IL (US)

(21) Appl. No.: 13/229,522

(22) Filed: Sep. 9, 2011

(51) Int. Cl. C01B 39/04; C01B 39/06; C01B 39/02

(52) U.S. Cl. 423/703; 423/700; 423/702; 423/713

(57) ABSTRACT

Methods for forming zeolites having a substantially uniform distribution of zeolitic crystallites are provided. In a method, a source of microscopically homogeneous amorphous silica alumina is prepared. Pores in the microscopically homogeneous amorphous silica alumina are filled with a crystallization agent. Then, the microscopically homogeneous amorphous silica alumina is converted to a zeolite with a substantially uniform distribution of zeolitic crystallites.

### FIELD OF THE INVENTION

The present invention generally relates to methods for forming zeolites, and more particularly relates to methods for forming zeolites from homogeneous amorphous silica alumina

### BACKGROUND OF THE INVENTION

Generally, crystallization is the slowest step in zeolite synthesis. Slow crystallization rates result in the formation of large crystals and in high production costs. Zeolite is commonly mixed with a binder to create a mixture that can be formed into catalysts possessing geometric shapes. During this process, the zeolite is dispersed into the binder as aggregates of zeolitic crystallites, significantly reducing the utilization efficiency and yield.

Accordingly, it is desirable to provide methods for forming zeolites that are not hindered by slow crystallization steps. Further, it is desirable to provide methods for forming zeolites having substantially uniform distributions of zeolitic crystallites. Also, it is desirable to provide methods for forming zeolites from microscopically homogeneous amorphous silica alumina. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Methods for forming zeolites having substantially uniform distributions of zeolitic crystallites are provided. In accordance with an exemplary embodiment, a method for forming a zeolite having a substantially uniform distribution of zeolitic crystallites includes providing a source of microscopically homogeneous amorphous silica alumina. Pores in the microscopically homogeneous amorphous silica alumina are filled with a crystallization agent. Then the microscopically homogeneous amorphous silica alumina is converted to a zeolite with a substantially uniform distribution of zeolitic crystallites.

In accordance with another exemplary embodiment, a method of forming a zeolite includes mixing microscopically homogenous amorphous silica alumina with a crystallization solution and filling pores in the microscopically homogenous amorphous silica alumina with a crystallization agent. Further, the method includes heating the microscopically homogenous amorphous silica alumina and causing crystallization into a zeolite formed with a substantially uniform distribution of zeolitic crystallites.

In accordance with another exemplary embodiment, a method of forming a zeolite having a substantially uniform distribution of zeolitic crystallites includes preparing amorphous silica alumina with pores in a micro range order, and filling pores in the amorphous silica alumina with a crystallization agent. The amorphous silica alumina is heated, causing crystallization of zeolitic crystallites across the micro range order of pores to form the zeolite with a substantially uniform distribution of zeolitic crystallites.

### BRIEF DESCRIPTION OF THE DRAWING

The present invention will hereinafter be described in conjunction with the following drawing figure wherein:

FIG. 1 is a flow chart illustrating a method for forming zeolites having a substantially uniform distribution of zeolitic crystallites in accordance with an exemplary embodiment;

FIGS. 2-6 are scanning electron microscope images taken of zeolite in accordance with Example 3 and formed according to the method of FIG. 1;

FIGS. 7-11 are scanning electron microscope images taken of zeolite in accordance with Example 8 and formed according to the method of FIG. 1;

FIG. 12 includes graphs showing X-ray diffraction patterns for the sample zeolite example 7 (top graph) and example 9 (bottom graph).

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The various embodiments contemplated herein relate to zeolites having unique zeolitic structure, morphology, and catalyst porosity, and methods for preparing such zeolites at low cost. Specifically, methods are provided for converting highly homogeneous amorphous silica alumina to such zeolites, including Zeolite LTA, X, Y, MFI, BEA, and Mordenite. These zeolites may be appropriate for applications such as methanol to olefin (MTO) conversion; methanol to olefin/propylene (MTO-P) conversion; xylene isomerization; ethylbenzene (EB) de-alkylation; alkylation of aromatics with alkylating agents to produce, for example, ethylbenzene, cumene and linear alkylbenzene (LAB); alkylation of iso-paraffin with olefin for motor fuel production; fluidized catalytic cracking (FCC); and hydrocracking due to their efficient transport characteristics and robust hydrothermal stability.

It is contemplated herein that microscopically homogeneous amorphous silica alumina can be readily converted to zeolitic material under mild synthesis conditions at an extremely high rate. As a result, crystallization is removed as the rate-determining step in zeolite synthesis. Further, it is contemplated herein that utilizing microscopically homogeneous amorphous silica alumina, with its substantially uniform pore structure, is effective in controlling zeolitic crystallite formation. Also, using microscopically homogeneous amorphous silica alumina may provide for tailoring transport properties as desired. A catalyst containing zeolite resulting from the methods herein is essentially a uniform distribution of zeolite crystallite over a uniform pore structure. In other words, the resulting catalyst does not possess the zeolite aggregates that are typical of a catalyst made from conventionally synthesized zeolite and binder. Such zeolite aggregates lessen zeolite utilization and effectiveness and are avoided herein.

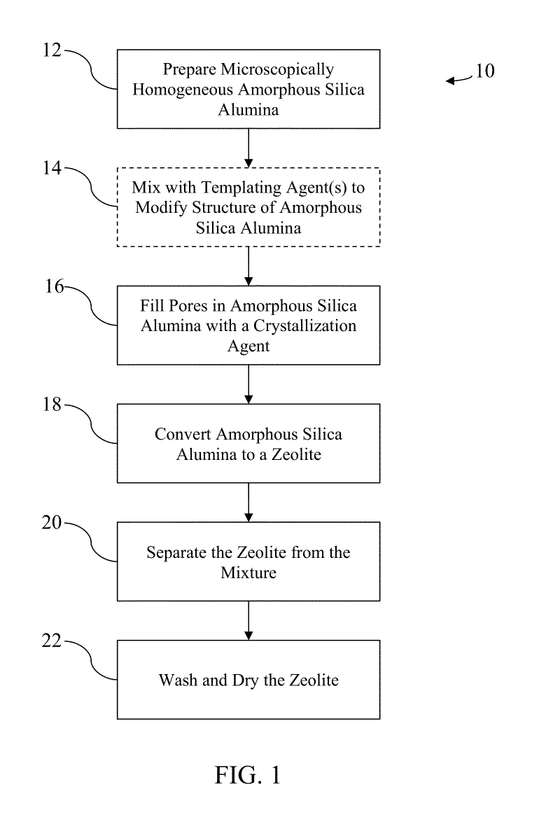

An exemplary method 10 for forming zeolites having a substantially uniform distribution of zeolitic crystallites is illustrated in FIG. 1. As used herein, a substantially uniform distribution of zeolitic crystallites is one in which the average diameter of crystallites is within 10% of each other. In method 10, a source of microscopically homogeneous amorphous silica alumina, whether dried or calcined, or in powder or in pre-form state, is prepared (step 12), preferably according to the preparation method described in U.S. Pat. No. 5,230,789, which is herein incorporated by reference. As a result, the pores in the microscopically homogeneous amorphous silica alumina are in the range from about 30 to 300A average pore diameter as per Hg intrusion measurement.

In an embodiment, the microscopically homogeneous amorphous silica alumina is prepared by mixing an alumina hydrosol and a silica hydrosol to form a mixture. Alumina sols are well known in the art and are prepared by digesting aluminum in a strong acid such as aqueous hydrochloric acid at about reflux temperatures, usually from about 80° C. to about 105° C. The aluminum to chloride ratio in the alumina sol is typically from about 0.7:1 to about 1.5:1 by weight. Silica sols are also well known in the art, and are prepared by acidifying water glass. The mixture of the two components must contain sufficient aluminum and silicon to provide a final product that contains from about 2 to about 50 weight percent Al₂O₃, from about 50 to about 98 weight percent SiO₂.

To prepare the microscopically homogenous amorphous silica alumina, the mixture described above must be gelled. For example, a gelling agent may be combined with the mixture described above. Then the resultant combined mixture is dispersed into an oil bath or tower which has been heated to elevated temperatures such that gelation occurs with the formation of spheroidal particles. The gelling agents which may be used in this process are hexamethylene tetraamine, urea or mixtures thereof. The gelling agents release ammonia at the elevated temperatures which sets or converts the hydrosol spheres into hydrogel spheres. The spheres are then continuously withdrawn from the oil bath and subjected to specific aging and drying treatments in oil and an ammoniacal solution to further improve their physical characteristics.

The resulting aged and gelled particles are then washed and dried at a relatively low temperature of about 93° C. to about 149° C. (200° F.-300° F.) and subjected to a calcination procedure at a temperature of about 454° C. to about 704° C. (850° F.-1300° F.) for a period of about 1 to about 20 hours. This provides a microscopically homogeneous amorphous solid solution of silicon and aluminum oxides.

Alternatively, the mixture of aluminum and silicon components may be gelled by spray drying the mixture or adding a gelling agent to the mixture and then spray drying. Spray drying may be carried out at a temperature of 100° C. to about 760° C. (212° F. to 1400° F.) at about atmospheric pressure. It should be pointed out, however, that the pore structure of a spray dried material may not be the same as the pore structure of a spheroidal material prepared by the oil drop method.

As stated, the microscopically homogeneous amorphous silica alumina herein is characterized as a solid solution of aluminum and silicon oxides. In other words, the microscopically homogeneous amorphous silica alumina does not contain separate phases of alumina and silica oxide. The microscopically homogeneous amorphous silica alumina may best be described as an alumina matrix which has been substituted with silicon atoms. The fact that amorphous precursor is microscopically homogeneous means that the silicon and aluminum are atomically mixed and it would be readily converted to crystalline phase with minimal transport.

The microscopically homogeneous amorphous silica alumina is also characterized in that it has pores whose average diameter ranges from about 30 to about 300 Å (Angstroms), has a pore volume of about 0.35 to about 0.75 cc/g (cubic centimeter per gram) and has a surface area of about 200 to about 420 m²/g (square meter per gram). An exemplary microscopically homogeneous amorphous silica alumina is between about 50% to about 98% SiO₂ and between about 2% to about 50% Al₂O₃.

Referring back to FIG. 1, it may be seen that in optional embodiments the amorphous silica alumina may be mixed with templating agents such as quaternary ammonium salts, including for example tetrabutylammonium bromide (TBABr), and/or hexamethonium salts, including for example hexamethonium dichloride (HMCl), and water to form a mixture (step 14). These templating agents serve to change the morphology of the amorphous silica alumina. If this optional step is used, the mixture is dried after mixing.

The method continues with filling the pores of the amorphous silica alumina with a crystallization agent, preferably sodium hydroxide (step 16). The sodium hydroxide serves to support an ensuing crystallization reaction. In this regard, a sodium hydroxide solution, such as, for example, a 35% sodium hydroxide solution, is added to and mixed with the microscopically homogeneous amorphous silica alumina While conventional zeolite synthesis may employ 200 to 300 moles of water per mole of alumina for pore filling, the pore-filling step of the exemplary embodiment uses only about 50 to about 60 moles of water per mole of alumina.

After mixing the amorphous silica alumina with the crystallization agent to form the homogeneous mixture, the microscopically homogeneous silica alumina is converted to a zeolite (step 18). Specifically, the mixture is heated at a selected temperature, such as 80° C. or 100° C., for a desired duration. Depending on the desired zeolitic composition and method, the desired duration may be between about 16 to 96 hours. Due to the elevated temperature, the caustic conditions imposed by the presence of crystallization agent, and the relatively small volume of water required for pore filling, the amorphous silica alumina is caused to undergo crystallization at a relatively fast rate. As a result of crystallization, the amorphous silica alumina is converted into zeolite material with a substantially uniform distribution of zeolitic crystallites. Further, due to the increased crystallization rate, very small crystallites are formed, for example, having diameters of 200-300 nanometers (nm). The crystallites are formed with a well constructed pore structure, efficient transport properties, and robust thermal and hydrothermal stability.

As illustrated in FIG. 1, the zeolite is separated from the mixture, preferably through use of a centrifuge (step 20). Then the zeolite is washed and dried (step 22). The resulting exemplary zeolite has a Si/Al ratio of between about 1.2 and 2.0, preferably between about 1.4 and 1.8, more preferably between about 1.6 and 1.75, and still more preferably about 1.7. In certain embodiments, the zeolite may be processed further, for example, through ion exchange with rare earth mineral, ion exchange with lanthanum chloride, and/or ion exchange with ammonium. Such treatments may be used to alter behavior of the zeolite for its intended use.

The following are examples of zeolites having a substantially uniform distribution of zeolite crystallites fabricated as described above. The examples are provided for illustration purposes only and are not meant to limit the various embodiments of the present invention in any way.

### Example 1

Formation of Microscopically Homogeneous Amorphous Silica Alumina In Example 1, metallic aluminum was digested in dilute hydrochloric acid at a temperature of about 102° C. to yield a hydrosol containing polymeric alumina hydroxy chloride in about 0.88 Al:Cl weight ratio (12.5 wt. % Al). Then it was mixed with aqueous hexamethylene tetraamine (HMT) solution to provide a hydrosol containing an HMT:Cl molar ratio of 0.4. The mixture was maintained at 5° C. to 10° C.

A batch of acidified water glass was prepared by adding concentrated HCl to a diluted water glass such that a Cl:Na molar ratio of 1.10 and a SiO₂ content of 11% was achieved. The alumina sol was then added to the acidified water glass to form an acidic solution containing alumina and silica hydrosol.

The hydrosol was formed into spheroidal hydrogel particles by emitting the hydrosol as droplets into a dropping tower containing an oil suspending medium at a temperature of about 95° C. The spherical gel particles were aged in a portion of the gas oil for about 19 hours at about 100° C. After the aging treatment, spheres were washed with water at a temperature of about 95° C. and subsequently dried at a temperature of about 120° C. for a period of two hours. Finally, the amorphous silica/alumina spheres were calcined at a temperature of about 650° C. for about 2 hours in the presence of (3% H₂O) moist air.

The properties of the spheres prepared according to the above procedure are presented in Table 1.

TABLE 1
Properties of Spherical Particles

| | Sample 1 | Sample 2 |
|---|---|---|
| Wt. % P₂O₅ | 0 | 0 |
| Wt. % Al₂O₃ | 50 | 25 |
| Wt. % SiO₂ | 50 | 75 |
| X-ray Phase I.D. | Amorphous | Amorphous |
| Surface Area | 336 | 372 |
| Pore Volume (cc/g) | 0.68 | 0.64 |
| Pore Diameter (Å) | 81 | 68 |

### Example 2

In Example 2, amorphous silica alumina according to Sample 2 of Example 1 was obtained. About 100 grams of the amorphous silica alumina were placed into a 1000 mL polytetrafluoroethylene bottle. Then, 160 grams of 35% sodium hydroxide solution were added to the amorphous silica alumina dropwise. The components were mixed until homogeneous, with the sodium hydroxide filling the pores in the amorphous silica alumina. The homogeneous mixture was heated in an oven at 80° C. for 27 hours. During heating, zeolites having a substantially uniform distribution of zeolite crystallites were formed across the pores.

After heating, the solid zeolite was separated from other components with a centrifuge. The zeolite solid was washed three times with deionized water and dried. X-ray diffraction analysis determined that the zeolite had the FAU structure. The zeolite was RE (rare earth) exchanged using a 0.5 mole (M) solution of lanthanum chloride at 75° C. for two hours. The zeolite was filtrated and washed. The zeolite was steamed at 550° C. for 1.5 hours. Then it was ion exchanged with ammonium (NH₄) using a 1M solution of ammonium nitrate (NH₄NO₃) at 75° C. for two hours. The zeolite was then filtrated, washed, and dried at 100° C. Inductively coupled plasma chemical analysis determined a Si/Al ratio of 1.75 and a La/Al ratio of 1.175. The zeolite was bound with 20% alumina binder and exhibited a surface area of 484 square meters per gram (m²/g) and a matrix pore volume of 0.22 cubic centimeters per gram (cc/g).

### Example 3

In Example 3, amorphous silica alumina according to Sample 2 of Example 1 was obtained. About 100 grams of the amorphous silica alumina were placed into a 1000 mL polytetrafluoroethylene bottle. Then, 160 grams of a 35% solution of sodium hydroxide were added to the amorphous silica alumina dropwise. The components were mixed until homogeneous with the sodium hydroxide filling the pores in the amorphous silica alumina. The homogeneous mixture was heated in an oven at 80° C. for 27 hours. During heating, zeolites having a substantially uniform distribution of zeolite crystallites were formed across the pores.

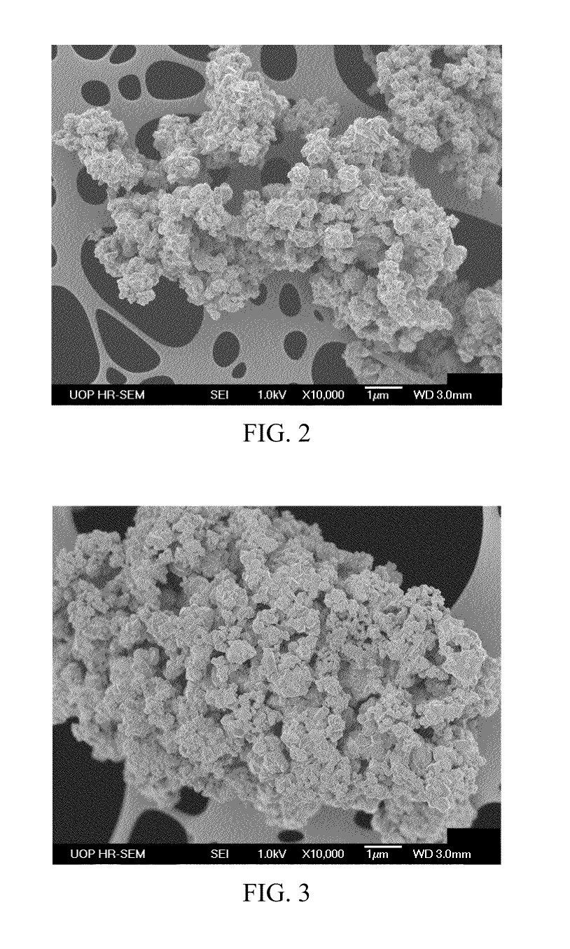

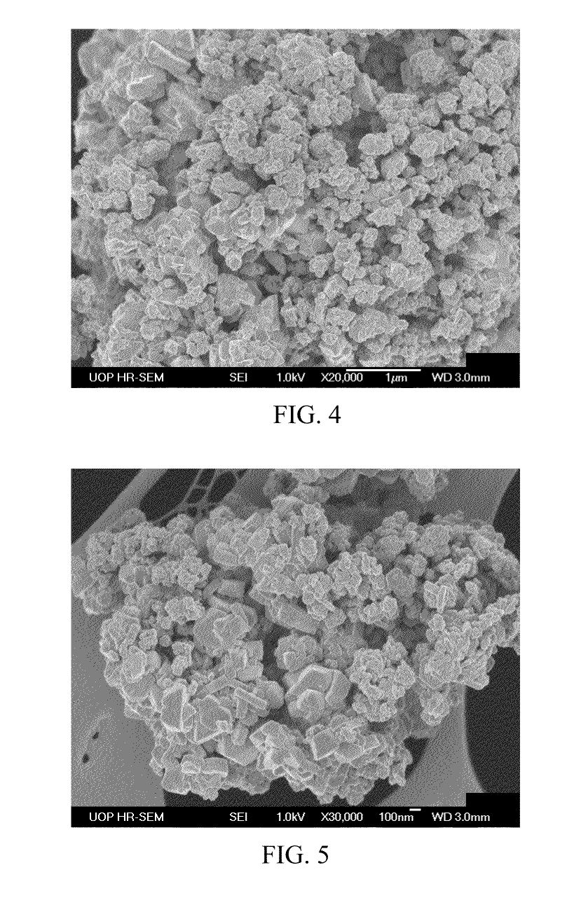

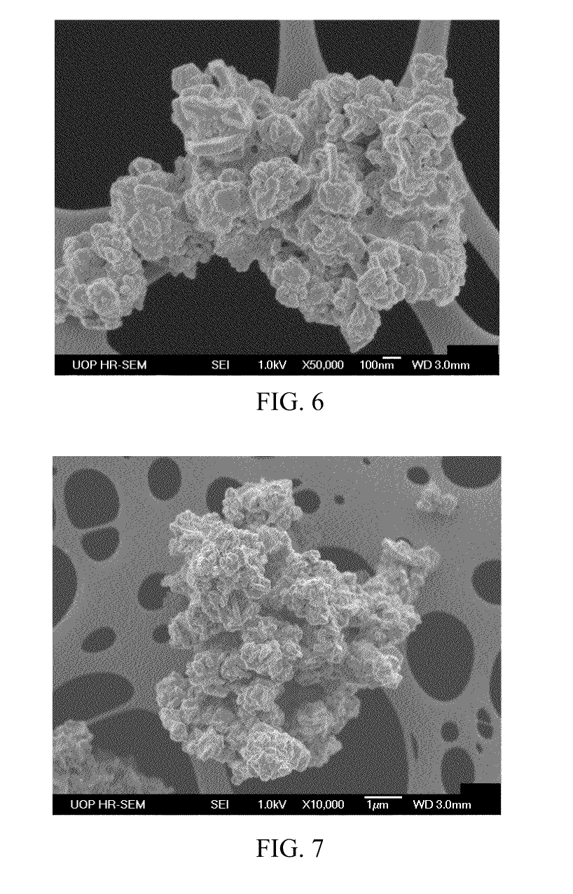

After heating, the solid zeolite was separated from other components with a centrifuge. The zeolite solid was washed three times with deionized water and dried. X-ray diffraction analysis determined that the zeolite had the FAU structure. Inductively coupled plasma chemical analysis determined a Si/Al ratio of 1.6. High resolution scanning electrode microscope analysis showed a discrete small crystal size between 20 nm and 100 nm with plate morphology. FIGS. 2 through 6 show the structure of the zeolite of Example 3.

### Example 4

In Example 4, five grams of 80% SiO₂ and 20% Al₂O₃ amorphous silica alumina were formed in accordance with Example 1 and were placed into a 100 milliliter (mL) polytetrafluoroethylene bottle. Then, two grams of tetrabutylammonium bromide (TBABr), two grams of hexamethonium dichloride (HMCl), and three grams of water were added to the amorphous silica alumina. The amorphous silica alumina was allowed to dry for two hours while the templating agents (TBABr and HMCl) changed the morphology of the amorphous silica alumina.

Eight grams of a 35% solution of sodium hydroxide (NaOH) prepared by dissolving 350 grams of sodium hydroxide in 650 grams of water were added to the amorphous silica alumina dropwise. The components were mixed until homogeneous, with the sodium hydroxide filling the pores in the amorphous silica alumina The homogeneous mixture was heated in an oven at 100° C. for 16 hours. During heating, zeolites having a substantially uniform distribution of zeolite crystallites were formed.

After heating, the solid zeolite was separated from other components with a centrifuge. Then, the zeolite solid was washed three times with deionized water and dried. X-ray diffraction analysis determined that the zeolite had the FAU structure. Inductively coupled plasma chemical analysis determined a Si/Al ratio of 1.5. High resolution scanning electrode microscope analysis showed a discrete small crystal size between 20 nm and 500 nm.

### Example 5

Amorphous silica alumina was formed as 80% SiO₂ and 20% Al₂O₃ according to the process described in Example 1. About 100 grams of the amorphous silica alumina were placed into a 1000 mL polytetrafluoroethylene bottle. Then, 40 grams of TBABr, 40 grams of HMCl, and 60 grams of water were added to the amorphous silica alumina The amorphous silica alumina was allowed to dry for two hours while the templating agents modified the structure of the amorphous silica alumina.

After drying, 160 grams of a 35% solution of sodium hydroxide were added to the amorphous silica alumina dropwise. The components were mixed until homogeneous, with the sodium hydroxide filling the pores in the amorphous silica alumina The homogeneous mixture was heated in an oven at 80° C. for 26 hours. During heating, zeolites having a substantially uniform distribution of zeolite crystallites were formed.

After heating, the solid zeolite was separated from other components with a centrifuge. The zeolite solid was washed three times with deionized water and dried. X-ray diffraction analysis determined that the zeolite had the FAU structure. Inductively coupled plasma chemical analysis determined a Si/Al ratio of 1.7.

### Example 6

Amorphous silica alumina was formed as 80% SiO₂ and 20% Al₂O₃ according to the method of Example 1. Five grams of the amorphous silica alumina were placed into a 100 mL polytetrafluoroethylene bottle. Then, 2 grams of TBABr, 2 grams of HMCl, and 3 grams of water were added to the amorphous silica alumina The amorphous silica alumina was allowed to dry for two hours while the templating agents changed the structure of the amorphous silica alumina.

After drying, 8 grams of a 35% solution of sodium hydroxide were added to the amorphous silica alumina dropwise. The components were mixed until homogeneous, and then heated in an oven at 100° C. for 48 hours. During heating, zeolites having a substantially uniform distribution of zeolite crystallites were formed.

After heating, the solid zeolite was separated from other components with a centrifuge. The zeolite solid was washed three times with deionized water and dried. X-ray diffraction analysis determined that the zeolite had the FAU structure. Inductively coupled plasma chemical analysis determined a Si/Al ratio of 1.8.

### Example 7

Amorphous silica alumina was formed as 85% SiO₂ and 15% Al₂O₃ according to the process of Example 1. About 10 grams of the amorphous silica alumina were placed into a 100 mL polytetrafluoroethylene bottle. Then, 16 grams of a 35% solution of sodium hydroxide were added to the amorphous silica alumina dropwise. The components were mixed until homogeneous, with the sodium hydroxide filling the pores in the amorphous silica alumina. The homogeneous mixture was heated in an oven at 80° C. for 71 hours. During heating, zeolites having a substantially uniform distribution of zeolite crystallites were formed.

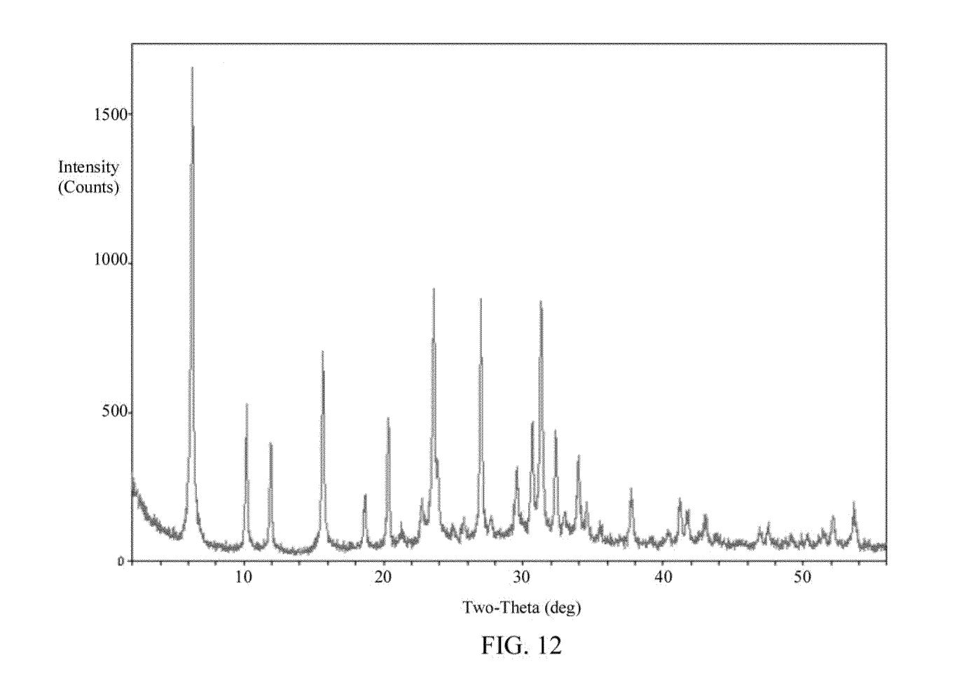

After heating, the solid zeolite was separated from other components with a centrifuge. The zeolite solid was washed three times with deionized water and dried. X-ray diffraction analysis determined that the zeolite had the FAU structure. Representative diffraction pattern is shown in the top graph of FIG. 12. Inductively coupled plasma chemical analysis determined a Si/Al ratio of 1.8. High resolution scanning electrode microscope analysis showed a discrete small crystal size between 20 nm and 100 nm with plate morphology.

### Example 8

Amorphous silica alumina was formed as 80% SiO₂ and 20% Al₂O₃ according to the process of Example 1. Five grams of the amorphous silica alumina were placed into a 100 mL polytetrafluoroethylene bottle. Then, 8 grams of a 35% solution of sodium hydroxide were added to the amorphous silica alumina dropwise. The components were mixed until homogeneous, with the sodium hydroxide filling the pores of the amorphous alumina silica. The homogeneous mixture was heated in an oven at 80° C. for 96 hours. During heating, zeolites having a substantially uniform distribution of zeolite crystallites were formed.

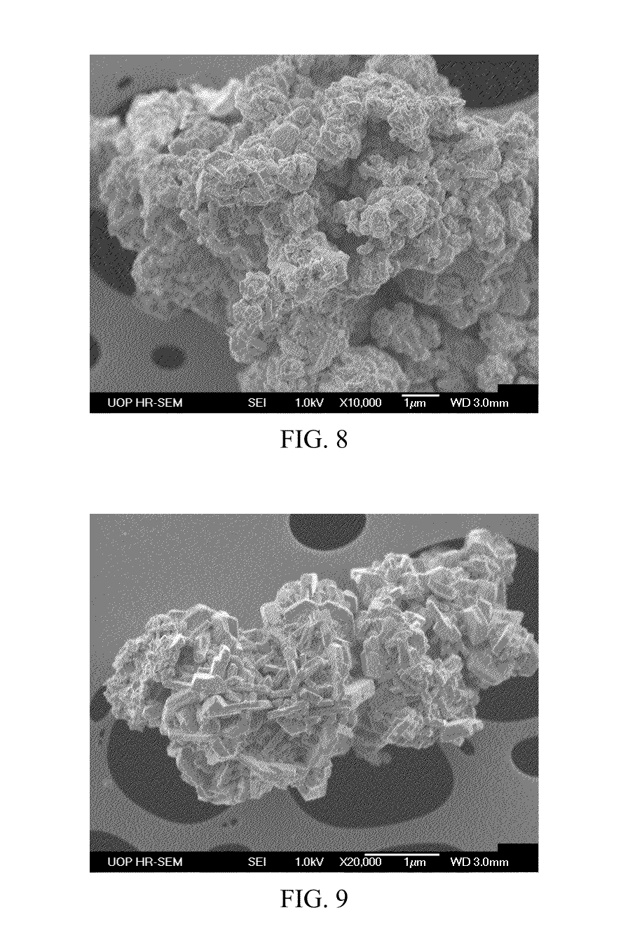

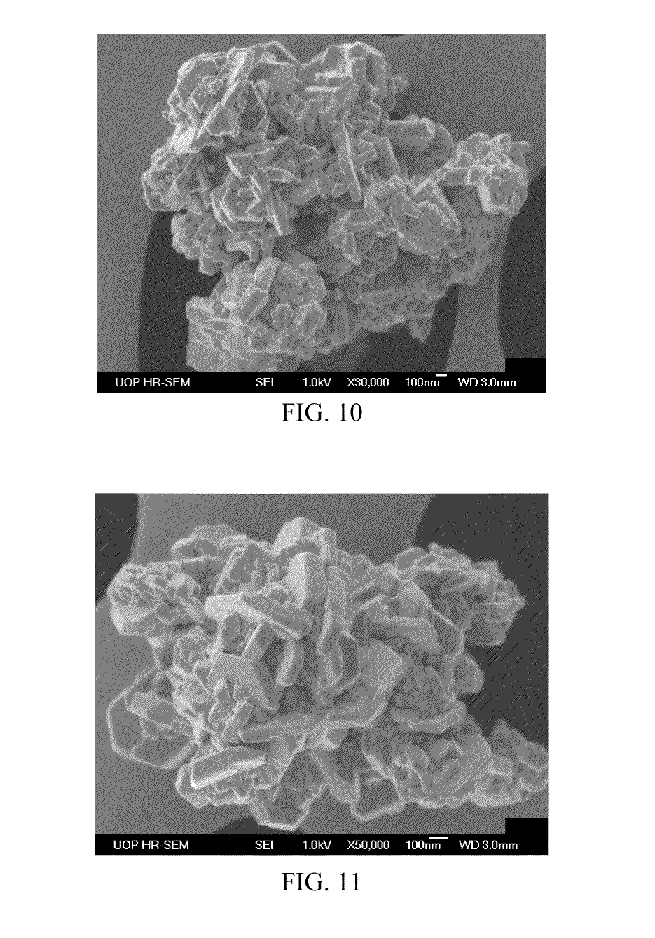

After heating, the solid zeolite was separated from other components with a centrifuge. The zeolite solid was washed three times with deionized water and dried. X-ray diffraction analysis determined that the zeolite had the FAU structure. Inductively coupled plasma chemical analysis determined a Si/Al ratio of 1.4. High resolution scanning electrode microscope analysis showed hexagonal plate morphology. FIGS. 7 through 11 show the hexagonal plate morphology of the zeolite of Example 3.

### Example 9

Amorphous silica alumina was formed as 80% SiO₂ and 20% Al₂O₃ according to the process described in Example 1. About 10 grams of the amorphous silica alumina were placed into a 100 mL polytetrafluoroethylene bottle. Then 16 grams of a 35% solution of sodium hydroxide were added to the amorphous silica alumina dropwise. The components were mixed until homogeneous, with the sodium hydroxide filling the pores in the amorphous silica alumina. The homogeneous mixture was heated in an oven at 80° C. for 69 hours. During heating, zeolites having a substantially uniform distribution of zeolite crystallites were formed.

After heating, the solid zeolite was separated from other components with a centrifuge. The zeolite solid was washed three times with deionized water and dried. X-ray diffraction analysis determined that the zeolite had the FAU structure. Representative diffraction pattern is shown in the bottom graph of FIG. 12. Inductively coupled plasma chemical analysis determined a Si/Al ratio of 1.5.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method of forming a zeolite, the method comprising the steps of:
providing a source of microscopically homogeneous amorphous silica alumina;
filling pores in the microscopically homogeneous amorphous silica alumina with a crystallization agent; and
converting the microscopically homogeneous amorphous silica alumina to a zeolite with a substantially uniform distribution of zeolitic crystallites.

2. The method of claim 1 wherein filling comprises mixing the microscopically homogeneous amorphous silica alumina with sodium hydroxide solution to form a homogeneous mixture with sodium hydroxide impregnating the pores.

3. The method of claim 2 wherein filling creates a water-to-alumina mole ratio of about 50:1 to about 60:1.

4. The method of claim 1 further comprising mixing at least one organic templating agent and water with the microscopically homogeneous amorphous silica before the filling.

5. The method of claim 4 further comprising mixing tetrabutylammonium bromide, hexamethonium dichloride, and water with the microscopically homogeneous amorphous silica alumina before filling.

6. The method of claim 1 further comprising:
exchanging ions between the zeolite and a rare earth mineral;
exchanging ions between the zeolite and lanthanum chloride; and/or
exchanging ions between the zeolite and ammonium.

7. The method of claim 1 further comprising separating the zeolite from remaining components.

8. The method of claim 7 further comprising drying the separated zeolite, wherein the dried zeolite has a Si/Al ratio in the range of between about 1.2 and about 2.0.

9. The method of claim 1 wherein preparing comprises:
mixing an alumina hydrosol and a silica hydrosol to form a mixture;
gelling the mixture to form particles; and
calcining the particles to form the microscopically homogeneous amorphous silica alumina.

10. The method of claim 9 wherein calcining comprises:
calcining the particles to form the microscopically homogeneous amorphous silica alumina, and wherein the microscopically homogeneous amorphous silica alumina comprises between about 50% to about 98% SiO₂ and between about 2% to about 50% Al₂O₃.

11. A method of forming a zeolite comprising:
mixing microscopically homogenous amorphous silica alumina with a crystallization solution comprising a crystallization agent and filling pores in the microscopically homogenous amorphous silica alumina with the crystallization agent; and
heating the microscopically homogenous amorphous silica alumina and causing crystallization into a zeolite formed with a substantially uniform distribution of zeolitic crystallites.

12. The method of claim 11 wherein heating comprises maintaining the microscopically homogenous amorphous silica alumina at a temperature of about 80° C. for at least 16 hours.

13. The method of claim 11 further comprising treating the microscopically homogenous amorphous silica alumina with at least one templating agent before mixing.

14. The method of claim 11 wherein the crystallization solution is sodium hydroxide solution and wherein mixing comprises mixing microscopically homogenous amorphous silica alumina with the sodium hydroxide solution,

15. The method of claim 14 wherein the crystallization agent is sodium hydroxide, and wherein filling comprises filling pores in the microscopically homogenous amorphous silica alumina with sodium hydroxide.

16. The method of claim 11 further comprising drying the zeolite, wherein the dried zeolite has a Si/Al ratio in the range of from about 1.4 to about 1.8.

17. The method of claim 11 wherein preparing comprises:
mixing an alumina hydrosol and a silica hydrosol to form a mixture;
gelling the mixture to form particles; and
calcining the particles to form the microscopically homogenous amorphous silica alumina, wherein the microscopically homogenous amorphous silica alumina comprises between about 50% to about 98% SiO₂ and between about 2% to about 50% Al₂O₃.

18. A method of forming a zeolite having a substantially uniform distribution of zeolitic crystallites, the method comprising the steps of:
preparing amorphous silica alumina with pores in a micro range order;
filling the pores in the amorphous silica alumina with a crystallization agent; and
heating the amorphous silica alumina and causing crystallization of zeolitic crystallites across the micro range order of pores to form the zeolite with a substantially uniform distribution of zeolitic crystallites.

19. The method of claim 18 wherein the crystallization agent is sodium hydroxide and wherein filling comprises impregnating the pores in the amorphous silica alumina with sodium hydroxide.

20. The method of claim 19 wherein filling comprises impregnating the pores in the amorphous silica alumina with sodium hydroxide to create a water-to-alumina mole ratio of about 50:1 to about 60:1.
